(19) United States
(12) Patent Application Publication
(10) Pub. No.: US 2008/0304365 A1
(43) Pub. Date: Dec. 11, 2008

(54) Method For Time Based Event Structure and Compliance

(76) Inventors: Carl Jarvis, Mt.Laurel, NJ (US); James Gentilin, Lumberton, NJ (US)

Correspondence Address: LICATA & TYRRELL P.C., 66 E. MAIN STREET, MARLTON, NJ, 08053, US

(21) Appl. No.: 11/997,562

(22) PCT Filed: Aug. 3, 2006
(86) PCT No.: PCT/US06/30367

§ 371 Date: Jul. 2, 2008

Related U.S. Application Data
(60) Provisional application No. 60/705,211, filed on Aug. 3, 2005.

(51) Int. Cl. G04B 47/00

(52) U.S. Cl. 368/10

(57) ABSTRACT

Processes to create events and record the time and date of events, records, schedules, and medication and lifestyle regimens, statically and dynamically, are provided.

This patent application claims the benefit of priority from U.S. Provisional Application Ser. No. 60/705,211, filed Aug. 3, 2005, teachings of which are herein incorporated by reference in their entirety.

### FIELD OF THE INVENTION

The present invention relates to a process to record the time and date, inclusive of, but not limited to the ability to improve the safety of medication and lifestyle compliance for the betterment of the individual, by means of creating events, records, schedules, and medication and lifestyle regimens dynamically.

### BACKGROUND OF THE INVENTION

Reports have shown that almost two-thirds of Americans currently use medicines. However, a major problem in treating illness today is patients' failure to take medications correctly. More than half of all Americans with chronic disease do not follow accurately dosing regimes or lifestyle guidance set forth by their physicians. Failure to take prescription medications correctly leads to 10 percent of all hospital admissions and 23 percent of all nursing home admissions.

U.S. Pat. No. 6,198,695 discloses a method and apparatus for monitoring patient compliance using a multiple step event acknowledgement process involving programming a device with the event times and descriptions, comparing the event times to a system time, alerting the patient when an event is to occur, pausing the alert, waiting a predetermined amount of time, and acknowledging the alert after pausing and before the end of the predetermined amount of time. The apparatus consists of a portable device with a microcontroller with memory for storing the event times and descriptions and a prompting means for alerting the patient and event pause and acknowledgment of functions. The portable device may include a microphone for allowing the patient to record verbal message for later replay by a clinician.

U.S. Pat. No. 6,198,383 discloses a prescription compliance device and a method for using this device to remind a patient when the next dose of medications is to be taken and what dose should be taken. The device includes a microcontroller, a display, a program memory for storing pre-programmer medication-taking regimens for single and multiple medications, a real time clock, a selector for selecting one of the regimens and for programming the device as to time and day on which the first dose of medication is to be taken, a display which alternately displays the current time and time when the next dose of medication is to be taken, and an alarm which alerts the patient at times when a dose of medication is to be taken. The selector includes an event switch which is activated by the patient after taking a dose of medication so as to record the taking of the medication and to cause the microcontroller to effect the display of the next time at which a dose of medication is to be taken. The device may further comprise memory to record the times at which a patient takes doses of medication. The device is sized to be attached to a medication container and includes a remote programming feature via wireless link.

U.S. Pat. No. 6,633,796 discloses a medication timing device which can be fastened to a medication container which comprises a base carrying a circuit with a timing device, a switch for activating the timing device, a signal device activated by the timing device, a battery coupled to the timing device and the signal device and a top coupled to the base and covering the circuit. The top is moveable between a normal expanded position and a compressed position in which the switch is tripped. The timing device is activated for a single unchangeable interval of time and a signal is emitted upon termination of the interval of time.

However, the systems and devices that are currently on the market to aid in medication and lifestyle compliance are inadequate due to their limitations with static or fixed based time and dates for use with reminders and dosing regimens. These systems and devices rely on the individual to enter and maintain complex regimens which conform to the fixed based schedule. They don't address the dynamics in which people live, nor do they address the individuals understanding of complex regimens and complex drug associations. All of the systems and devices which utilize a fixed time and date methodology are all plagued with the situation surrounding non-compliance and the “missed dose” scenario. The underlining problem with the missed dose is; how does the individual handle the missed dose with regards to his next dose. This is the case where the fixed time date methodology can not handle the dynamics of the daily life schedule. There are also products out on the market that utilize a count down timer to establish the future expiration time and date. The current application of timers is limited to one instance, is limited to time only, and is limited to the same event.

Systems and devices which address compliance issues typically only deal with required prescription medications. These systems and devices which try to address prescription medications which are “as-needed”, or other non-prescription medications redefine the medications as required by establishing them within a specified regimen or compliance schedule based on fixed times and dates. These systems and devices do not properly address prescription medications which are “as-needed” and over-the-counter (OTC) medications which still need to be taken, and taken safely, but usually fall outside the scope of compliance devices.

In addition to a compliance schedule, there are other safety concerns with medications including OTC medications, vitamins, supplements, and herbal remedies which are taken “as-needed” which can cause harm to the individual when taken with other medications. There are many contraindications including known food reactions and drug-to-drug interactions.

### SUMMARY OF THE INVENTION

The present invention provides a means to define event structure(s) based on content, date(s), time(s) and relation(s) in particular to improving the safety of medication administration and aid individuals with medication and lifestyle compliance by use of reference to the time and date of the compliance in order to dynamically change the event content in association with safety issues regarding recommended or safe intervals, and limitations within the event, or associated events. The ability to record events dynamically also provides the means of establishing a chronological historical database.

An objective of the present invention is to determine future actions with regards to events, and reminders, based on time and date records established by the current time and date of the recording of the record. This also refers to independent, dependent, and other relationships within the event structure. Defining independent, dependent, and other relationships within the event structure allows for dynamic interactions of events and records, and may include event specific reminders. The events may also have dependent, specified time and date intervals, as well as limitations. These limitations may restrict the event within a specified time and date. The ability to allow dynamic changes within an event structure will allow the ability to alter the event schedule based on the understanding of directions of use, dose intervals, dose limitations, drug properties, contraindications, drug interactions, food allergies, or conditions. Conditions which can affect the use of drugs may include, but are not limited to, diabetes, asthma, pregnancy, breast feeding, surgical procedures, liver disease, kidney disease, and high blood pressure.

If a record for an event, inclusive of, but not limited to medications, is not established, the event will be treated as being already expired. This is a primary difference of the present invention over all other products on the market. In addition, if the record for an event is not established, the events expiration time and date may be affected by records of other events.

When addressing the concerns regarding medication and lifestyle compliance, the ability to create a unique event and record the current time and date for a unique event allows the individual to automatically establish an ideal compliance schedule based on preferences, or lifestyle patterns. This provides complete flexibility in the schedule.

### DETAILED DESCRIPTION OF THE INVENTION

The present invention provides a process to create an event and record the action associated with a current event by recording the current time and date of the action specific to the event as a record.

For the purpose of the present invention, by “event”, it is meant any specified type of information, which may or may not require a future action, or may or may not be set to expire at a future time and date.

By “event structure”, as used herein, it is meant any organizing attribute, as defined but not limited to, type, variables, elements, tags, or references of the event.

By “event content”, as used herein, it is meant any data, value, or coded value within the event structure.

By “record”, as used herein it is meant an archive of an event with a specific time and date, or time/date stamp, recorded by the current time and date of the action, or entered as a past time and date. The record also refers to archived events based on past time and date up to and including the current time and date.

By “current time and date”, for the purpose of the present invention, it is meant the time and date at a particular instance represented by the local time as established by other means. The local time may be based on the UTC (Coordinated Universal Time), local time offsets to the UTC, or it may be based on other methodologies. Alternatively, or in addition, a record may be entered for an event by establishing a past time and date for a previous action of an event creating a historical reference. Time and date analysis of the record is used in event structures for calculating the expiration time and date of a future action of the event, or other event(s). In addition to time and date analysis, there are also variables within the event structure which can effect the calculations of future expiration dates and times of the event or reminders associated with the event and may include, but are not limited to, intervals, limitations, windows, and relations, such as, dose quantity, dose intervals, not to exceed limitations, take with, do not take with, take 1 hour after meals, etc. Records may also apply to static information such as events associated with a hospital stay, immunizations, or discharge information and discharge instructions.

By “limitation”, for purposes of the present invention, it is meant internal references within the event structure, inclusive of but not limited to, limits, not to exceed dosing limitations within a specified time period, duration, stop indicators, medications which need to be taken at meals, contraindications, drug-to-drug interactions, drug-to-drug restrictions, time and date restrictions, or event-to-event dependencies.

By “relation”, for the purposes of the present invention it is meant internal and external references between events, inclusive of but not limited to, events which have a known or identifiable association. This may include contraindications, drug-to-drug interactions, drug-to-drug restrictions, time and date restrictions, or event-to-event dependencies. It may also include associations with symptoms, common uses, and side effects. This can also include associations with non medical and non medicine events like meals and an event based on blood glucose readings at fixed times after the meal.

By “window”, for the purpose of the present invention it is meant a specific beginning time and date, ending time and date, or both associated with a reference time and date.

To establish a date time baseline, in a preferred embodiment, the time and date may be based on the UTC which allows the modification of the time and date based on time zones. Standards for time and date formats such as ISO 8601 are widely accepted and supported by the World Wide Web Consortium (W3C). Using the UTC with international time zones allows calculations within the event structures associated with individuals who travel across time zones and internationally, as well as use modifications to the local zone associated with daylight savings. The date time baseline may be defined as the date, time, or time and date. Other benefits in using the ISO 8601 standard is the representation of time intervals, and recurring time intervals. The time and date origin may or may not be based on any specific format, reference, or calculation. The representation of the time and date is not limited and may be presented in any number of formats including, but not limited to Readable Text, ASCII text, or any other conversion or calculation. The time and date may be calculated, calculated and stored as a value, or based on a stored value alone. The time may be based on a 12 hour or 24 hour reference. Other methodologies may be used for generation of the time and date inclusive of, but not limited to, satellite or radio wave technologies.

Method of entering data for this process of the present invention are not restricted as part of this present invention and can be entered by any means capable of entering such data, such as a personal device, PDA, personal computer, host computer, cell phone, or any other device capable of accepting data entry via the device itself or through a wired or wireless communication protocol. Examples of wireless communication protocols include, but are not limited to satellite, telecommunications, VoIP, voice input, user prompts, etc. A preferred embodiment of the present invention relates to the event content, data, or structure and is not limited to medication, reminders, and lifestyle events. The present invention relates to time and date event content and structure and how events with relations interact with event records associated with time and date content.

When a user enters information to define a new event structure and the event is set to remind, the event will have no previous records and therefore will automatically be expired. This is also true for all new events which are set up to automatically create a regimen or schedule. If the event is set to remind but there are other limitations within the event structure, such as a time window, then the event will still remain expired, but the system will not set the reminder as expired, it will be calculated based on the limitations.

An example of this is a medication which is to be taken one time daily in the morning. If you were creating a new event for this medication the night before, the event, if queried, would state that it was expired, but there would be no reminder to take the medication until the next morning. The next morning, a reminder would have expired for the event and the query on the event would also be expired. In the case where the medication was set to remind and auto calculate a schedule, the auto schedule would look up a interval value within the event structure or calculate the interval, which in this case was daily or 24 hours, and set the next reminder for the medication to expire 24 hours in the future.

Another example of this is to automatically set a reminder to check your blood glucose levels 1 hour after you eat. When you are done eating, you record the fact that you ate by recording the current time and date. The system will then process that time and date and then set a reminder to take your blood glucose level in 1 hour.

These examples provide a simplistic view of dynamic scheduling which can become more complex with intervals, limitations, windows, complex tapers, or sliding scales, or internal and external event relations, all defined as variable, and time and date based variables within an event structure. In addition to dynamic time and date reference, the user can also set static time and date references, events, and records. As an example, the user can set a reminder to check their blood glucose level every morning at 8:00 AM.

Variables and content within the event structure allow the ability to establish records, intervals, limits, windows, and relations for the purpose of entering, calculating, or referencing future expiration dates and times based on the variables and content of the event structure and associated event structure(s). Variables and content within the event structure may or may not be manually entered and may be calculated or created using mapping techniques or standards based on, but not limited to medication SIG data, RxNorm, NCPDP, SNOMED CT, ASTM-CCR, HL7, CDA, NDC, LOINC, ICD-9-CM, or ICD-10 codes.

Methods of recording the action of an event are not restricted as part of the present invention and can be defined by any means capable of identifying the action to be recorded including but in no way limited to a personal device, PDA, personal computer, host computer, wireless devices, etc. A preferred embodiment of the present invention is the inclusion of the actual time/date stamp of the action with respect to the event structure, content and records.

The ability to record, or time/date stamp, the current time and date for a unique event and calculate future event actions allows an individual to develop a regimen or schedule which models a lifestyle instead of trying to force a lifestyle to model a regimen or schedule. The purpose of the recorded time and date is to establish a period of time between a past record of a time and date, or reference point, and the current time and date. This also provides the capability to employ pattern recognition in automatically defining regimens and schedules dynamically. This is particularly useful for events which are recurring and may be affected by an occurrence of the same event, or a different event occurring which has a relationship to the first event. An example of an interval in a dynamic setting is where the time and date record of the adherence to the medication regimen calculates when the medication may be taken again. An example of a limitation is where a medication may be taken every 4 hours but is restricted as not to exceed 4 doses in 24 hours. An example of an event with a relation to another event is where drug interactions and side affects may be caused by other conditions like, “do not take within 4 hours of drinking grapefruit juice”. Adverse Drug Reactions (ADRs), drug intervals and interactions are a serious threat to individuals and may cause serious harm and may even be fatal based on the toxicity of the drug, or the condition of the individual. Events may be recorded using digital voice recordings of the event with event content entered by prompts or other input means.

In the present invention, events and records are time based. In addition, the event or record structure may include references to classes, subclasses, or coded values of the event or record structure for the purpose of data analysis and traceability. Examples of coded values may represent creation dates, last modified dates, or author.

Further exemplary nonlimiting embodiments of the present invention include the following:

### EXAMPLES

### Example 1

### Method of Establishing a Time and Date Origin

This embodiment of the method of the present invention may reference the UTC. The time and date origin may or may not be based on any specific format, reference, or calculation. It may be presented in any number of formats, Readable Text, ASCII text, binary conversion, hex conversion, etc. The time and date may be calculated, calculated and stored as a value, or based on a stored value alone. The time may be based on a 12 hour or 24 hour reference. The method of obtaining the value may also include other technologies such as satellite.

### Example 2

### Method of Establishing a Local Time and Date Based on a Specific Time Zone

This embodiment of the method of the present invention may include reference to the UTC with a local time offset. The method of obtaining the value may also include other technologies such as satellite or radiofrequency (RF) transmission.

### Example 3

### Method of Establishing a Time and Date Offset

This embodiment of the method of the present invention may reference the local time offset to the UTC, or alterations within a time zone like day light savings. The method of obtaining the value may also include other technologies such as satellite or radiofrequency (RF) transmission.

### Example 4

### Method of Establishing Event Content which is Time and Date Sensitive or Time and Date Based

This embodiment of the method of the present invention may include, but is not limited to, specific dates and times, dose intervals, recurring intervals, limit intervals, set limits, calculations using dates and times, and windows.

### Example 5

### Method of Establishing a Time and Date Record for a Specific Event Represented, or Calculated as a Value and Units of Date, Time, or Time and Date

In this embodiment of the method of the present invention, the time and date of a record may be calculated, calculated and stored as a value, or based on a stored value alone. This is also commonly known as a date/time stamp.

### Example 6

### Method of Establishing a Time and Date Interval for a Specific Event Represented, or Calculated as a Value and Units of Date, Time, or Time and Date

In this embodiment of the method of the present invention, the interval may also include recurring time intervals.

### Example 7

### Method of Establishing a Time and Date Interval Limit for a Specific Event Represented, or Calculated as a Value and Units of Date, Time, or Time and Date

### Example 8

### Method of Establishing a Time and Date Window for a Specific Event Represented, or Calculated as a Value and Units of Date, Time, or Time and Date

This embodiment of the method of the present invention is used as a compliance window for auto scheduling-no creep.

### Example 9

### Method of Establishing Event Relations

### Example 10

### Method of Establishing a Future Expiration Time and Date of an Event by Manually Entering a Specific Future Expiration Time and Date

This embodiment of the method of the present invention provides the ability to manually enter a regimen.

### Example 11

### Method of Establishing a Dynamic Regimen or Schedule Based on Time and Date Records of an Event and Calculated Future Expiration Time and Dates of an Event

### Example 12

### Method of Calculating the Future Expiration Time and Date of an Event Based on a Time and Date Interval Represented, or calculated as a value and units of date, Time, or Time and Date

In this embodiment of the method of the present invention, the expiration time and date of an event may be calculated, calculated and stored as a value, or based on a stored value alone.

### Example 13

### Method of Calculating the Future Expiration Time and Date of an Event Based on a Time and Date Limit Represented, or calculated as a value and units of date, Time, or Time and Date

In this embodiment of the method of the present invention, the expiration time and date of an event may be calculated, calculated and stored as a value, or based on a stored value alone.

### Example 14

### Method of Calculating the Future Expiration Time and Date of an Event or Event Relation Based on a Time and Date Interval and Limit Represented, or Calculated as a Value and Units of Date, Time, or Time and Date

In this embodiment of the method of the present invention, the expiration time and date of an event may be calculated, calculated and stored as a value, or based on a stored value alone. This is “doses not to exceed XX in 24 hours”, and overrides the “doses every XX hours.”

### Example 15

### Method of Calculating the Future Expiration Time and Date of an Event Based on a Time and Date of an Event Relation Associated with a Different Event Represented, or Calculated as a Value and Units of Date, Time, or Time and Date

In this embodiment of the method of the present invention, the expiration time and date of an event may be calculated, calculated and stored as a value, or based on a stored value alone.

### Example 16

### Method of Calculating the Future Expiration Time and Date of an Event Based on a Record Time and Date of the Same Event Represented, or Calculated as a Value and Units of Date, Time, or Time and Date

In this embodiment of the method of the present invention, the expiration time and date of an event may be calculated, calculated and stored as a value, or based on a stored value alone.

### Example 17

### Method of Calculating the Future Expiration Time and Date of an Event Based on a Record Time and Date of a Different Event, Represented, or Calculated as a Value and Units of Date, Time, or Time and Date

In this embodiment of the method of the present invention, the expiration time and date of an event may be calculated, calculated and stored as a value, or based on a stored value alone. These calculations may be based on drug interactions of another drug, or calculation based on other events like food intake, insulin injections, etc.

### Example 18

### Method of Referencing Time and Date Content within an Event Structure Represented as a Value and Units of Date, Time, or Time and Date

### Example 19

### Method of Referencing a Time and Date Used in a Record Represented as a Value and Units of Date, Time, or Time and Date

### Example 20

### Method of Establishing a Future Expiration Time and Date of a Reminder Based on a Record Time and Date and a Window Time and Date of the Same Event Represented, or Calculated as a Value and Units of Date, Time, or Time and Date

In this embodiment of the method of the present invention, the expiration time and date of an event may be calculated, calculated and stored as a value, or based on a stored value alone. For pattern regimen matching, if the record date/time is within a selected specified time period of the previous record date/time, then the expiration date time will be the expiration date with the previous record time.

### Example 21

### Method of Establishing Event Content Based on Information Contained within any Other System or Standard

This embodiment of the method of the present invention uses any method or any other means of referring to or mapping information contained in those systems or standards, inclusive of, but not limited to SIG Codes, RxNorm, NCPDP, SNOMED CT, ASTM-CCR, HL7, CDA, NDC, or LOINC, ICD-9-CM, or ICD-10 codes.

The method of the present invention is not limited by the particular method of entering data selected. Data can be entered by any means such as a personal device, PDA, personal computer, host computer, any wireless communication protocol including telecommunications, VoIP, voice input, user prompts, medical information systems, databases, etc.

Reminders within the event structure reference the content specified within the event and may or may not represent the expiration of the event.

What is claimed is:

1. A process to create an event which may or may not require a future action, or may or may not be set to expire at a future time and date comprising entering into a device event content associated with the event or event structure.

2. The process of claim 1 further comprising determining an expiration date or time of the event based on the event content.

3. The process of claim 1 further comprising determining an expiration date or time of the event based on event relations.

4. The process of claim 1 wherein the expiration date or time is the event is automatically set to expire upon creation.

5. The process of claim 1 wherein the event relates to medication administration or lifestyle compliance.

6. The process of claim 1 wherein the event is created by entry of the event content associated with the event or event structure into a personal device, PDA, personal computer, host computer, cell phone, or any other device capable of accepting data entry via the device itself or through a wired or wireless communication protocol.

7. A process to record an action associated with a current event comprising recording a current time and date of the action specific to the current event as a record in a device.

8. The process of claim 7 further comprising determining a future action with regard to an event or reminder based upon the recorded record of the current time and date of the action.

9. The process of claim 8 wherein recording the record and determining the future action improves safety of medication administration and aids with medication and lifestyle compliance.

10. The process of claim 7 further comprising establishing a chronological historical database of recorded records.

11. The process of claim 7 wherein the event is recorded and the future event is determined by entry of the current time and date of the action into a personal device, PDA, personal computer, host computer, cell phone, or any other device capable of accepting data entry via the device itself or through a wired or wireless communication protocol.

12. The process of claim 7 wherein the event relates to medication administration or lifestyle compliance.
